(19) United States
(12) Patent Application Publication
(10) Pub. No.: US 2008/0137553 A1
(43) Pub. Date: Jun. 12, 2008

(54) METHOD OF AUTOMATIC CERTIFICATION AND SECURE CONFIGURATION OF A WLAN SYSTEM AND TRANSMISSION DEVICE THEREOF

(76) Inventors: Yi-Shou Hsu, Hsin-Chu City (TW); Yung-Fang Huang, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 11/609,341

(22) Filed: Dec. 12, 2006

(51) Int. Cl. H04L 12/28

(52) U.S. Cl. 370/254

(57) ABSTRACT

A method of automatic certification and secure configuration of a wireless local area network (WLAN) includes performing a first configuration at a wireless access point (AP), executing a connection program at a client terminal corresponding to the first configuration, increasing a relative signal strength indicator (RSSI) threshold, and creating a connection between the access point and the client terminal create and entering an automatic configuration process.

### BACKGROUND OF THE INVENTION

1. Field of the Invention

The invention relates to wireless networks, and more particularly, to certification and secure configuration of a local area wireless network (WLAN).

2. Description of the Prior Art

Wireless network users need to be able to connect to a wireless network within the coverage area of the network. Even though wireless networks enjoy the convenience of being free of wired connections, when deploying a wireless network, the security of the wireless environment must also be considered. In general, network security includes the following two important factors: 1. connection control, and 2. data encryption. Connection control ensures that only authorized users are able to store and extract encrypted data via the wireless network. Data encryption ensures that data passing through the wireless network can only be received and understood by designated users.

Currently, the 802.11 standard commonly used includes two types of wireless client certification mechanisms including open style and shared key style. Additionally, there are two other mechanisms commonly in use being the Service Set Identifier (SSID) and Media Access Control (MAC) address certification. Modifying the SSID setting is quite difficult for users unfamiliar with wireless networks due to the fact that when the SSID of an access point is changed, the SSIDs of wireless cards utilizing the access point must also be correspondingly changed. This process is an obstacle to many users unfamiliar with wireless network cards, and therefore the first basic barrier of defense of a wireless network is unable to be utilized. The result is that wireless local area networks are more easily broken into by hackers.

Concerning data encryption, the 802.11 standard utilizes the wired equivalent privacy (WEP) security method to protect the safety of data transferred between the wireless access point and client terminals. WEP often utilizes 64-bit or 128-bit length keys with RC4 encryption to encrypt data on the wireless network. However, the RC4 encryption process actually exposes several portions of the keys, and these key portions can be utilized to obtain a WEP key required for storing and extracting data on the wireless network. Afterwards, it is very easy to steal information on the wireless network by breaking the encryption. The overall security of the network is thereby reduced, and this is a disadvantage of the encryption utilized by current wireless networks.

### SUMMARY OF THE INVENTION

One objective of the claimed invention is therefore to provide a simple and secure device for configuring a wireless network, to solve the above-mentioned problems.

According to an exemplary embodiment of the claimed invention, a method of automatic certification and secure configuration in a wireless local area network is disclosed. The method comprises the following steps: performing a first configuration at an access point; executing a connection configuration program at a terminal, the connection configuration program corresponding to the first configuration; increasing a received signal threshold; and creating a connection between the access point and the client terminal, and entering an automatic configuration process.

According to another exemplary embodiment of the claimed invention, a method of automatic certification and performing encrypted secure wireless local area network transmission configuration is disclosed. The method comprises the following steps: activating a configuration button on an access point; executing a connection configuration program on a terminal, the connection configuration program corresponding to the configuration button; entering an automatic configuration process with the access point and the terminal; setting up a wired equivalent privacy key (WEP key) in a medium access control layer (MAC layer) with both the access point and the terminal; sending a configuration request packet from the terminal to the access point requesting a required service set identifier (SSID) and an encryption key; receiving the configuration request packet by the access point and generating the service set identifier (SSID) the encryption key; inserting the service set identifier and the encryption key into a response packet and sending the response packet from the access point to the terminal; and receiving the service set identifier and the encryption key from the response packet by the terminal to thereby complete wireless network system automatic configuration.

According to another exemplary embodiment of the claimed invention, a transmission device utilized in a wireless local area network is disclosed. The transmission device at least comprises a terminal including a first connection module; and an access point including a second connection module, the second connection module including an automatic configuration selection corresponding to the first connection module; wherein starting the first connection module and the automatic configuration selection of the second connection module is for causing the terminal and the access point to enter an automatic configuration process.

According to another exemplary embodiment of the claimed invention, a method of automatic certification and secure configuration in a wireless local area network is disclosed. The method comprises the following steps: performing a first configuration at an access point; and executing a connection configuration program at a terminal, the connection configuration program corresponding to the first configuration; wherein the access point and the terminal are for entering an automatic configuration process, and the automatic configuration process is for utilizing a message-digest algorithm 5 (MD5) to thereby generate a service set identifier and an encryption key.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a local area wireless network according to an exemplary embodiment of the present invention.

FIG. 2 shows a flowchart describing a method for certification of a wireless network system according to an exemplary embodiment of the present invention.

### DETAILED DESCRIPTION

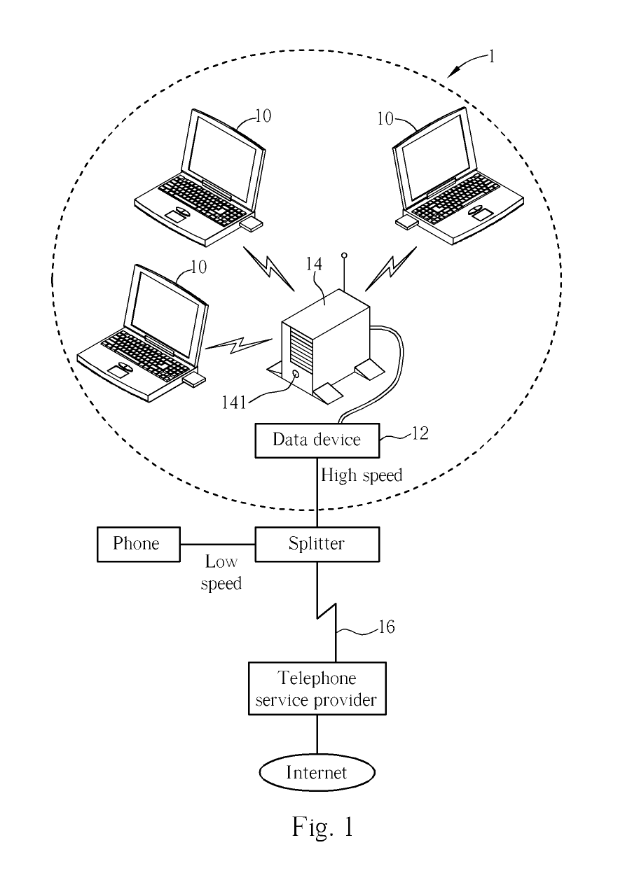

Please refer to FIG. 1 showing a block diagram of a local area wireless network 1 according to an exemplary embodiment of the present invention. The local area wireless network 1 includes user terminals 10 each having a first connection module (not shown), a wireless access point 14 having a second connection module (not shown), an easy-configuration (EASY-CONFIG) configuration button 141, a data device 12, a splitter, and a communication line 16 connecting a telephone service provider to the Internet or an area network.

Between a terminal 10 (e.g., a desktop computer or a notebook computer) and the wireless access point 14, by pressing the EASY-CONFIG configuration button 141 and performing a connection configuration program of the first connection module, the access point 14 and the terminal 10 are made to enter an automatic configuration process. After the connection configuration is completed, information can be passed from the access point 14, through the data device 12, the splitter, and the communication line 16 to the Internet.

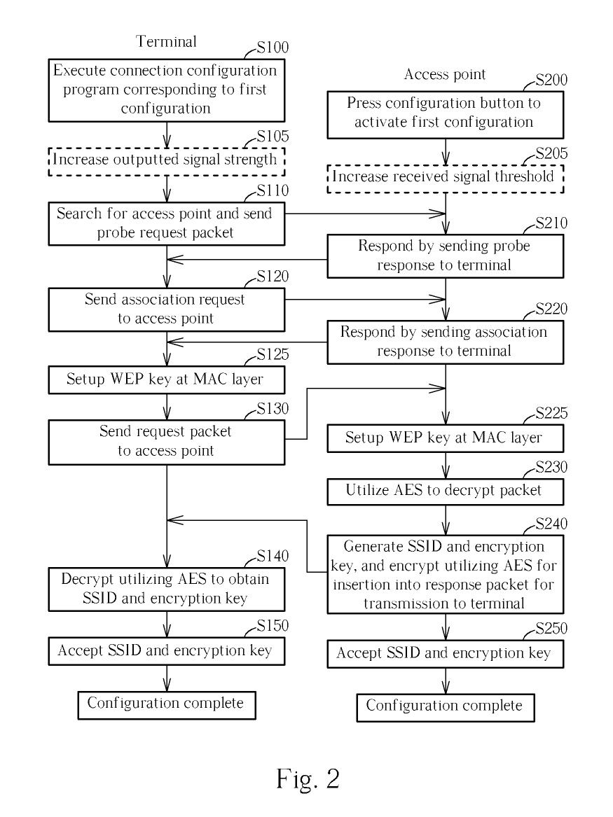

Please refer to FIG. 2 showing a flowchart describing a method for certification of a wireless network system according to an exemplary embodiment of the present invention. Firstly, at step 200, the EASY-CONFIG configuration button 141 of the access point 14 is pressed. At this time (step 205), the access point 14 increases a threshold for the received signal strength intensity (RSSI). At step 100, the terminal 10 enters a configuration program and performs an EASY-CONFIG selection. At step 105, the program controls the second connection module of the terminal to operate, which thereby increases the value of an output signal and makes the value of the output signal greater than the now elevated RSSI threshold of the access point 14. In this way, because the RSSI threshold of the access point is raised, only terminals within an effective distance from the access point can perform handshaking. This prevents people who are a far distance from the access point 14 from secretly listening. The terminal 10 and the access point 14 then enter an automatic configuration process and start performing the connection process of the 802.11 standard.

At step 110, the terminal 10 searches for an access point 14 and sends a probe request packet including a group of predetermined identification numbers utilized to replace the original manually entered SSID and allow further configuration to continue to be performed. At step 210, the access point 14 receives the probe request packet and confirms the packet contains a correct identification number. Afterwards, the access point 14 returns a probe response packet to the terminal 10. At step 120, the terminal 10 continues by sending an association request to the access point 14 to try and setup a connection. At step 220, the access point 14 sends an association response to the terminal 10. At step 125 and step 225, after the connection is setup, the terminal 10 and the access point 14 both setup a WEP key at the MAC layer utilized to encrypt all data sent in following steps. The key is generated according to the MAC address.

At step 130, the terminal sends a configuration request packet to the access point 14 to request the required SSID and encryption key. This request is sent in broadcast format utilizing user datagram protocol (UDP) being first encrypted utilizing the advanced encryption standard (AES) encryption standard and the entire packet is sent encrypted utilizing WEP of the 802.11 standard. At step 230, when the access point 14 receives and has properly decrypted the packet, message-digest algorithm 5 (MD5) is utilized to generate the SSID and encryption key. The access point 14 receives the generated SSID and encryption key, and afterwards takes this information and places it in a configuration response packet that is sent to the terminal 10. In the same way, AES and WEP algorithms are utilized to encrypt and send the information. The terminal 10 receives the SSID value and the authorized key from the access point 14, and completes the wireless network system automatic configuration.

After completing the wireless network system automatic configuration, the RSSI threshold value previously increased in step 205 is returned to its original value.

As previously stated, the present invention only needs an EASY-CONFIG button to be activated at an access point and a connection configuration program to be executed at a terminal. This makes the two devices enter an automatic configuration process and setup a connection. In contrast to the related art, the present invention reduces the complexity of the procedure. Additionally, because it is necessary to press the EASY-CONFIG button before the configuration process will be started, the present invention has the advantage of being effective to prevent unauthorized users from trying to break in. When transmitting data wirelessly, the present invention not only utilizes encryption included by the WEP algorithm of the original 802.11 standard, but further utilizes AES encryption to increase the difficulty of unauthorized decryption.

Additionally, when transmitting information between the access point and the terminal, the MD5-HASH obtains a one-time authorization key, and does not require performing client name and password encryption. The resulting security is greater than a fixed network key. In the configuration process, other authorized users can still normally access the wireless network. That is, there is no interference to these users by the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatic certification and secure configuration in a wireless local area network, the method comprising the following steps:
performing a first configuration at an access point;
executing a connection configuration program at a terminal, wherein the connection configuration program corresponds to the first configuration;
increasing a received signal threshold; and
creating a connection between the access point and the client terminal, and entering an automatic configuration process.

2. The method of claim 1 further comprising resetting the received signal threshold in the access point after entering the automatic configuration process.

3. The method of claim 1, wherein the received signal threshold is a received signal strength intensity (RSSI).

4. The method of claim 1, further comprising setting up a wired equivalent privacy key (WEP key) in a medium access control layer (MAC layer) after creating the connection between the access point and the client terminal.

5. The method of claim 4, further comprising generating the wired equivalent privacy key according to a MAC address of the access point and the terminal.

6. The method of claim 1, further comprising sending a configuration request packet from the terminal to the access point to request for a required service set identifier (SSID) and an encryption key.

7. The method of claim 6, further comprising generating the service set identifier and the encryption key by utilizing a message-digest algorithm 5 (MD5).

8. The method of claim 6, further comprising broadcasting the configuration request packet utilizing a user datagram protocol (UDP).

9. The method of claim 6, further comprising encrypting the configuration request packet utilizing an advanced encryption standard (AES).

10. A method of automatic certification and performing encrypted secure wireless local area network transmission configuration, the method comprising the following steps:
activating a configuration button on an access point;
executing a connection configuration program at a terminal, wherein the connection configuration program corresponds to the configuration button;
the access point and the terminal entering an automatic configuration process;
setting up a wired equivalent privacy key (WEP key) in a medium access control layer (MAC layer) at both the access point and the terminal;
sending a configuration request packet from the terminal to the access point to request for a required service set identifier (SSID) and an encryption key;
receiving the configuration request packet by the access point and generating the service set identifier (SSID) the encryption key;
inserting the service set identifier and the encryption key into a response packet and sending the response packet from the access point to the terminal; and
receiving the service set identifier and the encryption key of the response packet by the terminal to thereby complete wireless network system automatic configuration.

11. The method of claim 10, further comprising after activating the configuration button, increasing a received signal strength intensity (RSSI) threshold.

12. The method of claim 10, further comprising after performing the corresponding connection configuration program, increasing a signal value of the terminal.

13. The method of claim 10, comprising encrypting the response packet utilizing an advanced encryption standard (AES).

14. A transmission device utilized in a wireless local area network, the transmission device comprising:
a terminal comprising a first connection module; and
an access point comprising a second connection module, wherein the second connection module comprises an automatic configuration selection corresponding to the first connection module;
wherein activating the first connection module and the automatic configuration selection of the second connection module is for the terminal and the access point to enter an automatic configuration process.

15. The transmission device of claim 14, wherein the automatic configuration process is for generating a service set identifier (SSID) and an encryption key.

16. The transmission device of claim 14, wherein the second connection module comprises an EASY-CONFIG configuration button.

17. The transmission device of claim 16, wherein the EASY-CONFIG configuration button is for the access point to enter the automatic configuration process.

18. The transmission device of claim 14, wherein the first connection module comprises a corresponding first connection configuration program corresponding to the second configuration module.

19. The transmission device of claim 18, wherein the connection configuration program is for the terminal to enter the automatic configuration process.

20. A method of automatic certification and secure configuration in a wireless local area network, the method comprising the following steps:
performing a first configuration at an access point; and
executing a connection configuration program at a terminal, wherein the connection configuration program corresponds to the first configuration;
wherein a connection between the access point and the terminal is built up for entering an automatic configuration process, and the automatic configuration process is for utilizing a message-digest algorithm 5 (MD5) to thereby generate a service set identifier and an encryption key.

21. The method of claim 20, further comprising increasing a received signal threshold.
